(19) United States
(12) Patent Application Publication
(10) Pub. No.: US 2025/0263311 A1
(43) Pub. Date: Aug. 21, 2025

(54) Method and apparatus for controlling water generation from surface moisture of large water reservoirs using a case based expert system

(71) Applicant: Jafar Mustafa Ahmed Muhdher, Makkah (SA)

(72) Inventor: Jafar Mustafa Ahmed Muhdher, Makkah (SA)

(21) Appl. No.: 18/443,340

(22) Filed: Feb. 16, 2024

(51) Int. Cl. C02F 1/26

(52) U.S. Cl. CPC C02F 1/26; C02F 2301/026; C02F 2301/04

(57) ABSTRACT

This invention aims at providing large amounts of fresh water using minimal electrical energy by extracting humidity in the air using temperature differences between the surface of a large water reservoir, like a sea, river or ocean, and its depth. It simulates the rainfall process, which occurs, when wet air hits on a cold surface, trapping components of the cloud before reaching the upper layers of the air. It directs the humid air from the surface of the reservoir into the device, where it is guided through adequately designed pipes, inflicting on the air stream changes in temperature and pressure, sufficient to form water drops. Sensors connected to a case-based expert system measure heat, humidity, pressure and flow of air and water in different parts of the device and enable the control of generated water amounts as well as diagnosing any failures enabling reliable, optimized and secure operation.

### TECHNICAL FIELD

This invention aims at providing large amounts of fresh water using minimal electrical energy by extracting the humidity in the air using the temperature differences between the surface of a large water reservoir, like a sea, a river or an ocean, and its depth. It simulates the rainfall process, which occurs, when wet air hits on a cold surface, trapping components of the cloud before reaching the upper layers of the air. The invention directs the humid air from the surface of the reservoir into the apparatus, where it is guided through adequately designed pipes, inflicting on the air stream changes in temperature and pressure, sufficient to form water drops. Sensors connected to a case-based expert system measure heat, humidity, pressure and flow of air and water in different parts of the apparatus and enable this way the control of generated water amounts as well as diagnosing any failures and enabling reliable, optimized and secure operation.

### PRIOR ART

This invention has the following features (marked below as f1-f5):
1—It aims at providing large amounts of fresh water
2—through extracting the humidity in the air, directing air from the surface of the sea into a apparatus submerged in water
3—using the temperature difference between air and sea water
4—minimizing the energy needed
5—Controlling the process through specialized processors connected to sensors, which monitor: Heat, humidity, pressure and flow of air and water in different parts of the apparatus.

FIG. 1 resumes the current known state-of-the-art related to those features, clearly showing gaps filled by this invention.

Known also are Case Based Expert Systems as described for example in [Case-Based Reasoning Introduction and Recent Developments Ralph Bergmann, Klaus-Dieter Althoff, Mirjam Minor, Meike Reichle, Kerstin Bach, 2009]. Case Based Reasoning (CBR) is reasoning by remembering: previously solved problems (cases) are used to suggest solutions for novel but similar problems. There are four assumptions about the world around us that represent the basis of the CBR approach: 1. Regularity: the same actions executed under the same conditions will tend to have the same or similar outcomes. 2. Typicality: experiences tend to repeat themselves. 3. Consistency: small changes in the situation require merely small changes in the interpretation and in the solution. 4. Adaptability: when things repeat, the differences tend to be small, and the small differences are easy to compensate for. FIG. 2 illustrates how the assumptions listed above are used to solve problems in CBR [Introduction to Machine Learning & Case-Based Reasoning, Maja Pantic, Course 395, Imperial College London]. Once the currently encountered problem is described in terms of previously solved problems, the most similar solved problem can be found. The solution to this problem might be directly applicable to the current problem but, usually, some adaptation is required. The adaptation will be based upon the differences between the current problem and the problem that served to retrieve the solution. Once the solution to the new problem has been verified as correct, a link between it and the description of the problem will be created and this additional problem-solution pair (case) will be used to solve new problems in the future. Adding of new cases will improve results of a CBR system by filling the problem space more densely.

Not known are water generation apparatus and methods possessing features: f1-f5 and controlled by using a CBR-bases expert system.

### Objective of the Invention

The objective of this invention is to obtain large amounts of water from humidity, abundantly available on the surface of large water reservoirs like seas, rivers and oceans, while in the same time optimizing energy used for this extraction and providing intelligent operation and maintenance decisions for all equipment used, utilizing CBR expert logic conditions, deduced from past experiences and predicted event information, hence guaranteeing smooth, secure and reliable operation of apparatus.

### Nature of the Invention

Desalination is usually based upon heating salt water to discard salts and impurities and condense the steam in a next step into fresh water. Scientists estimate the amount of water trapped in the lower air layer surrounding the earth at more than 3 trillion cubic meters. In coastal areas, water droplets appear on car glass, glasses, and metal surfaces due to slight variations in temperature. Known inventions extract water from air humidity, but the condensation method depends on mechanical tools such as heat exchangers located in air conditioning apparatus, which work via electric power to compress gas or liquid. In this invention condensation depends solely on the temperature and pressure difference between a steam of air induced at the surface of the water reservoir and the same steam, reaching water depths, after being pumped into the apparatus, leading thus to better efficiency and ease of installation, use and maintenance of utilized apparatus.

### Example of Accomplishment

### The Water Extraction Apparatus

### Apparatus Parts

FIG. 3 shows the components of the apparatus, wherein some highlights are:
1. Air-driven fan (1.1)
2. Metal cylinder (1.2 and 1.4) submerged in water to an ideal depth of 150 m and the ideal diameter of 100 m divided into two parts:
   a) The top part constituting two-thirds of the length of the cylinder. It's called: The Upper Water Tank (1.2)
   b) The lower part occupying the lower third of the cylinder and is called: The Lower Water Tank (1.4)
3. A spiral pipe that wraps around the well and works as a condenser (1.8)
4. Pipes to remove the air after condensation, enable flow to upper- and lower tanks (1.10, 1.6, 1.7)

It should be noted that there are complementary additives not seen in FIG. 3 such: A compressor maintaining the pressure at the upper tank at a desired, calculated threshold, air filters to capture the molecules and solid particles suspended in the air as well as ultraviolet lamps at the outlet of the water to sterilize them from microbes, in addition to pumps for drawing water that is collected in the well and to clean the well of impurities and precipitated salts in an easy way to reduce the cost of maintenance. Also: An attached computer system collecting data from different sensors and controlling the speed of rotation of the fan based upon decisions taken by the CBR in order to achieve optimal operating efficiency and consumption at the least amount of energy.

### Explanation of Apparatus Parts:

1. A fan of high-thrust pulls the air horizontally and pumps it vertically (1.1). The proposed dimensions are compatible with the ideal measurements of the well, determined by the below air flow study.
2. Condenser (1.8): The condenser represents a spiral pipe and a number of rings covering depth and diameter of the well. The total internal surface of the condenser reaching thus 49769 m². This represents the cold surface area that is exposed to air before reaching the bottom tank.
3. Upper reservoir (1.2): It is a waterproof refined metal cylinder which is salinity proof and has high heat conductivity. It represents the surface of the coolness that will be exposed to the air in the first stage.
4. Lower water reservoir (1.4): It represents an extension of the upper reservoir.
5. The air discharger pipe from the bottom reservoir (1.10). Metal pipe to discharge air from the lower water reservoir with 2-3 m diameter.
6. Water suction pipe from the upper water reservoir (1.6): Metal pipe to unload the upper reservoir of water.
7. Water suction pipe from the lower reservoir (1.7): Metal pipe to suck water out the lower tank.

### Apparatus Operation:

The surface of the sea evaporates due to the temperature differences between the water and the air, so humidity is formed. The apparatus brings the temperature of the air to the temperature of the water. This causes an adverse reaction to the humidity and decreases the temperature while humidity forms in the apparatus. The humidity in the upper tank and the speed of the air circulation in the condenser affects the condensation process to reach the highest level of condensation. The fan rotator is controlled by the sensors to maximize the condensation with the lowest energy consumption while maintaining stable operation. The apparatus can be made in small sizes to give sufficient amounts of water for individual use.

The following steps describe its operation:
1. The fan pulls the air horizontally and pumps it vertically to the top of the well (Upper Water Tank).
2. In the upper water tank, the air is compressed. High pressure helps speed up air circulation. At this stage the compressed high-humidity air interacts with the lower temperature through the surface of the tank, resulting in small amounts of water in the upper tank.
3. There is a hole in the top of the tank to enable the air to enter into the condenser. The diameter of condenser pipes gradually narrows down from 1.5 cm at the beginning to 0.75 cm at the output of the lower tank in order to raise the pressure of the air in all stages and especially before releasing it. This is the same function of compressors in the air conditioners which use Freon instead of air.
4. Water drops in the lower tank because of the cooling effect caused by releasing the air and also because of the collision of the air with the lower reservoir wall, which is cold because the surface of the lower reservoir touches the deep water.
5. A pipe is used to discharge the air from the lower reservoir and as a result, cold air can be used for cooling the desalination station and other operation equipment.
6. A pipe is used to pull water out of the upper tank via electric pumps.
7. A pipe is used to pull water out of the bottom tank via electric pumps as well. Note: All parts of the sea well are treated against salinity and have high heat conductivity.

### Airflow Study and its Effect on the Design

One of the most important requirements for designing an air flow system is to balance pressures and flows in all its parts. In the system studied here, the amount of air flow resulting from the fan pressure must be equal to the sum of pressures and flows in all components of the system. This is done by constantly controlling the fan operation according to changes in flows and pressures in the apparatus. The most important factors affecting pressures and flows in pipes are:
Inner diameter of the condenser: The flow speed increases and the pressure decreases as the diameter of the tube becomes smaller.
Condenser length: The pressure decreases as the length of the tube increases.
Pipe curvature: The curvature of the condenser tube leads to additional resistance to air flow, which contributes to a decrease in the total pressure in the tube.

When the flow speed in the condenser increases, the air pressure entering the condenser decreases. In order to minimize pressure-drop, it is necessary to balance the required flow rate speed with the appropriate pipe diameter. The high air flow in the condenser, which produces high speed, can create a danger to the apparatus because it causes irregular air flow, which leads to the appearance of air vortices inside the tube. Therefore, it is preferable that the air flow speed does not exceed 100 m/s (Mach 0.3) so as not to cause turbulent eddies and air flows that could reduce the efficiency of the apparatus or damage it. By understanding all these factors that affect the operation and efficiency of the apparatus, the pressure and velocity of flows in the pipes are taken into consideration to ensure stable and efficient operation of the apparatus.

After the air is compressed in the upper tank space to raise the pressure and increase the humidity, it flows into the condenser through a condenser entry hole. The following design options allow controlling air flow, producing maximum amounts of water, while safely operating the apparatus:
1. Reducing the diameter of the fan that pumps air into the apparatus.
2. Increasing the entry and exit diameter of the condenser in order to reduce the speed of the compressed air flowing through the upper tank so that the air speed is appropriate to maintain a practical value of the pressure, when air enters the condenser, while ensuring in the same time a continued flow of air.
3. Reducing the diameter of the air entry hole into the lower tank from the inlet hole in order to raise the pressure before entering the lower tank, in which the pressure is significantly lower than the condenser. Increasing the flow speed in the lower tank leads to condensing the largest amount of existing water.

Because the diameter of the condenser outlet is smaller than the diameter of its inlet, this will raise the air pressure at the end of the condenser before it is released into the lower tank, which must have a low pressure relative to the condenser in order for the moisture in the air entering the tank to quickly condense into water. As the pressure suddenly drops when it enters the lower tank, this causes a decrease in the temperature of the entering air, resulting in the formation of water droplets in the lower tank, and also due to the collision of the entering air with the wall of the lower tank, which is located in a cold environment below a depth of 150 meters.

A design-obstacle at this stage is air accumulation and raising the pressure and temperature in the lower tank, which leads to a decrease in the efficiency of water condensation in the apparatus. In order to solve this obstacle, one of the below two methods or both have to be used:
To avoid the process of accumulation of air which is pumped into the lower tank over time due to the rapid flow of air into the lower tank, not matched by a rapid and appropriate flow of air escaping from the lower tank to the external environment through the air outlet pipe, it is preferred that the air exit hole from the lower tank to the outside environment should be between 2-3 meters in order to ensure a quick exit of air and thus reduce the pressure and the temperature to the appropriate value for condensation in the lower tank.
A suction cup is placed above the air outlet opening of the apparatus to increase air flow to the external environment, where the pressure is 1 bar, which reduces the pressure and temperature of the lower tank and increases its efficiency.

Taking all above factors into consideration, FIG. 4 shows possible air-flow-study dependent dimensions of the apparatus as well as the expected throughput of water per day. Out of those possible dimensions the following were chosen to reflect practical, easy to implement design parameters:
The diameter of the fan is 25 meters.
Condenser inlet 150 cm.
Condenser outlet 75 cm.
Upper tank pressure 40 bar.
Average pressure of the upper tank is 10-15 bar.
The air outlet opening from the apparatus is 3 meters.

### Monitoring and CBR

The process underlying the current invention is based upon the idea of constructing solution pairs (cases) from collected equipment data and performed maintenance activities. In general, three main approaches to case-base organization can be distinguished: flat organization, clustered organization, and hierarchical organization. Also, a combination of these methods within the same case base is possible. Flat organization is the simplest case-base organization that yields a straightforward flat structure of the case base. Though advantageous due to its simplicity and facile case addition/deletion, a flat case-base organization imposes, in general, case retrieval based upon a case-by-case search of the whole case base. Hence, for medium and large case bases, this leads to time-consuming retrieval, yielding an inefficient CBR system. Clustered organization, originating in the dynamic memory model initially proposed by Schank [R. C. Schank, Dynamic memory: A theory of reminding and learning in computers and people. Cambridge, UK: Cambridge University Press, 1982.], is the type of case-base organization in which cases are stored in clusters of similar cases. The grouping of cases may be based on their mutual similarity (like in the case of the dynamic memory of experiences used by Pantic [M. Pantic, Facial Expression Analysis by Computational Intelligence Techniques. PhD thesis, Delft University of Technology, 2001], [M. Pantic and L. J. M. Rothkrantz, “Case-based reasoning for user-profiled recognition of emotions from face images”, Proc. IEEE Int'l Conf Multimedia and Expo, 2004.]) or on the similarity to some prototypical cases. The advantage of this organization is that the selection of the clusters to be matched is rather easy, as it is based upon the indexes and/or prototypical cases characterizing the clusters. A disadvantage is that it needs a more complex algorithm for case addition/deletion than a flat organised case base. Hierarchical organization, originating in the category-exemplar memory model of Porter and Bareiss [B. W. Porter and E. R. Bareiss, “PROTOS: Experiment in knowledge acquisition for heuristic classification tasks”, Proc. 1st Int'l Meeting on Advances in Learning, pp. 159-174, 1986.], is the case-base organization that is generally obtained when cases that share the same features are grouped together. The case memory is a network structure of categories, semantic relations, cases, and index pointers. Each case is associated with a category, while the categories are inter-linked within a semantic network containing the features and intermediate states referred to by other terms. Different case features are assigned different importance in describing the membership of a case to a category. It must be noted that this importance assignment is static; if it changes, the case-base hierarchy has to be redefined. A new case is stored by searching for a matching case and by establishing the relevant feature indexes. If a case is found with only minor differences to the new case, the new case is usually not retained. In turn, a hierarchical case-base organization facilitates fast and accurate case retrieval. However, its higher complexity implies a rather cumbersome case addition/deletion, potentially involving expensive case-base reorganization and an inapt case base evaluation and maintenance. In this invention flat case-based organization is adopted.

Given a description of a problem, a retrieval algorithm should retrieve cases that are most similar to the problem or situation currently presented to the pertinent CBR system. The retrieval algorithm relies on the indices and the organization of the case memory to direct the search to case(s) potentially useful for solving the currently encountered problem. The issue of choosing the best matching cases can be referred to as analogy drawing, that is, comparing cases in order to determine the degree of similarity between them. Many retrieval algorithms have been proposed in the literature up to date: induction search (e.g., ID3, [J. R. Quinlan, Programs for Machine Learning. San Mateo, USA: Morgan Kaufmann, 1993.]), nearest neighbor search, serial search, hierarchical search, parallel search, etc. (for examples, see [T. M. Mitchell, Machine Learning. Singapore: McGraw-Hill Companies Inc., 1997.]). The simplest form of retrieval is the kst-nearest-neighbor search of the case base, which performs similarity matching on all the cases in the case base and returns just one best match [T. M. Mitchell, Machine Learning. Singapore: McGraw-Hill Companies Inc., 1997.]. Nearest-neighbor retrieval is a simple approach that computes the similarity between stored cases and new input case based on weight features. A typical evaluation function is used to compute nearest-neighbor matching as shown in FIG. 5

Where wᵢ is the importance weight of a feature, sim is the similarity function of features, and fᵢ^{I} and fᵢ^{R} are the values for feature i in the input and retrieved cases respectively. FIG. 6 displays a simple scheme for nearest-neighbor matching. In this 2-dimensional space, case3 is selected as the nearest neighbor because similarity(NC, case3)>similarity(NC, case1) and similarity(NC, case3)>similarity(NC, case2).

This invention uses nearest-neighbor retrieval algorithms to find cases similar to the produced, new ones.

Generally, once a matching case is retrieved, it will not correspond to exactly the same problem as the problem for which the solution is currently being sought. Consequently, the solution belonging to the retrieved case may not be optimal for the problem presently encountered and, therefore, it should be adapted. Adaptation looks for prominent differences between the retrieved case and the current case, and then (most commonly) applies a formula or a set of rules to account for those differences when suggesting a solution. In general, there are two kinds of adaptation in CBR [I. Watson and F. Marir, “Case-base reasoning: A review”, The Knowledge Engineering Review, vol. 9, no. 4, pp. 327-354, 1994.]:
1. Structural adaptation applies adaptation rules directly to the solution stored in cases. If the solution comprises a single value or a collection of independent values, structural adaptation can include modifying certain parameters in the appropriate direction, interpolating between several retrieved cases, voting, etc. However, if there are interdependencies between the components of the solution, structural adaptation requires a thorough comprehension and a well-defined model of the problem domain.
2. Derivational adaptation reuses algorithms, methods, or rules that generated the original solution to produce a new solution to the problem currently presented to the system. Hence, derivational adaptation requires the planning sequence that begot a solution to be stored in memory along with that solution. This kind of adaptation, sometimes referred to as re-instantiation, can only be used for problem domains that are well understood. An ideal set of rules must be able to generate complete solutions from scratch, and an effective and efficient CBR system may need both structural adaptation rules to adapt poorly understood solutions and derivational mechanisms to adapt solutions of cases that are well understood. However, one should be aware that complex adaptation procedures make the system more complex but not necessarily more powerful. Complex adaptation procedures make it more difficult to build and maintain CBR systems and may also reduce system reliability and, in turn, user's confidence in the system if faulty adaptations are encountered due to, for example, incompleteness of the adaptation knowledge, which is the most difficult kind of knowledge to acquire [W. Mark, E. Simoudis and D. Hinkle, “Case-based reasoning: Expectations and results”, Case-Based Reasoning: Experiences, Lessons & Future Directions, D. B. Leake, (Ed.), pp. 269-294, AAAI Press, Menlo Park, USA, 1996.]. Therefore, in many CBR systems, adaptation is done by the user rather than by the system. Mark et al. report that in a well-designed system, the users do not perceive “manual” adaptation as something negative [W. Mark, E. Simoudis and D. Hinkle, “Case-based reasoning: Expectations and results”, Case-Based Reasoning: Experiences, Lessons & Future Directions, D. B. Leake, (Ed.), pp. 269-294, AAAI Press, Menlo Park, USA, 1996.]. This invention adopts a structural adaptation algorithm using simple parameter-value substitution as shall be seen below.

### Formalism

An expert system of the kind this invention is adopting may be best described and formulated in mathematical logics using horn programs (c.f. [Reasoning with Horn Clauses, Brachman & Levesque 2005] for a quick introduction). The following definitions serve in doing that.

### Definition—1: Horn Clauses

A clause (i.e., a disjunction of occurrences of variables which are called literals) is called a Horn clause if it contains at most one positive literal. Horn clauses are usually written as

$${L}_{1} , … , {L}_{n} ⇒ L ( ≡ ¬ {L}_{1} ∨ … ∨ ¬ {L}_{n} ∨ L )$$

$$or$$

$${L}_{1} , … , {L}_{n} ⇒ ( ≡ ¬ {L}_{1} ∨ … ∨ ¬ {L}_{n} ) .$$

where n>=0 and L is the only positive literal. A definite clause is a Horn clause that has exactly one positive literal. A Horn clause without a positive literal is called a goal. Horn clauses express a subset of statements of first-order logic. The programming language Prolog is built on top of Horn clauses. Prolog programs are comprised of definite clauses and any question in Prolog is a goal.

### Definition—2: SLD (Selection Function in Linear Resolution for Definite Clauses) Resolution

An SLD derivation of Cₘ from a set {C₁, . . . , Cₙ} of Horn clauses (with the non-negated literal in the first place, if it exists) is a sequence C₁, . . . , Cᵢ, . . . , Cₙ, Cₙ₊₁, . . . , Cₘ such that Cₙ₊₁ is the resolvent of Cᵢ (goal clause) and another C∈{C₁, . . . , Cₙ} for every j>n+1, Cⱼ is the resolvent of Cⱼ₋₁ and another C∈{C₁, . . . , Cₙ}. Every resolution step takes the form:

$$L ‘ ∨ C ‘ , ¬ L “ ∨ C “ \text{=>} ( C ‘ ∨ C “ ) ( MGU ( L ‘ , L “ ) )$$

Where an MGU is an assignment of truth values for literals in L′ and L″ which renders them syntactically equal. SLD resolution is complete for Horn clauses: A set of Horn clauses is unsatisfiable iff there exists an SLD refutation for it. This, as well as efficiency considerations, makes SLD resolution one of the safest ways to perform deductive queries. An Example illustrating SLD Resolution of Horn Clauses is the following:

Let the knowledge-base be KB={MotorDefect, MotorDefect⊃FanNotWorking, FanNotWorking ΛPowerShortage⊃FanNotReparable, MainPowerCut⊃FanNotWorking, FanNotWorking ΛPowerAvailable⊃FanReparable, PowerAvailable}, the Goal G={FanReparable}, then the SLD refutation sequence looks like this:

{¬FanReparable}=>{¬FanNotWorking,¬PowerAvailable}=>{¬FanNotWorking}=>{¬MotorDefect}=>[ ]

### Definition—3: CBR Cases

CBR cases are definte clauses wherein the body is called Problem and the unique, positive literal is called Solution. Any predicate, expressed in one or more clauses, in the body is called a Feature. CBR Case Knowledge bases are sets of definite clauses also called Programs.

### Definition—4: Nearest Neighbor Retrieval Algorithm

Algorithm 1

```
  Inputs : KB, new sought CBR case (C), set of weights of all features used in
all CBR cases
  Output : Set of pair-wise similar CBR cases
  Body : Set MaxSim= 0, SelectedCase = First Case in KB
      For all CBR cases C′:
      - Calculate MaxSim=similarity(C,C′) using the formula
        given in FIG. 5
      - If the calculated MaxSim is higher than the one stored,
        replace the one stored and the SelectedCase with C′
    ReturnSelectedCase
```

### Definition—5: Parameter-Value Substitution Algorithm

Algorithm 2

```
  Inputs : CBR case (C) , Set of Literal mappings of the form
M={{L₁>L₂}...{Lᵢ>Lⱼ}}
  Output : Modified CBR case
  Body : For all literals in C :
    If {Lₓ>L_{y}} is element of M : Replace Lₓ with L_{y} in C
```

Finally, an example illustrates best the accomplishment of this invention.

Failure reporting, troubleshooting and maintenance processes are usually performed manually in large-scale water generation systems. The time critical aspect of the failure is thus not protected against due to logistical challenges. A simple error can turn into a critical failure if not addressed in a timely fashion. The cost of simple repairs can spiral out of proportions if adequate measures are not taken expeditiously to remedy the situation.

An example of an environmental condition which can affect the fan is a motor defect caused by meteorological events. The current invention proposes a solution to this problem consisting of four parts:
Data Collection: A specially designed extreme weather module lets the system collect sensor readings about weather parameters which may affect the motor and transfer the data through an Ethernet connection to the internet. Ethernet or ADSL guarantees 24/7 availability as well as transfer reliability. Data is availed to interested parties in real-time through a website so that they can manually compare with weather forecasting sites to ensure viability of the information.
Event prediction: An application collects prediction data about selected, crucial parameters from various reliable sources (public weather-forecast services) and compares it to whatever was read through the weather module.
Decision making using CBR: CBR is immediately engaged when relevant parameters reach a threshold level already encountered before and stored in the knowledge base.
User Alerts: User or System admin is sent a message describing the event and the precautions taken to cope with it.

This proposed solution addresses the main aspects that are deficient in current large-scale water generation processes:

First, all critical alarms are reported instantaneously; hence corrective measures can be taken accordingly either by connected automatic systems or by supervisors. Not only is the presence of failure reported to the maintenance staff, but the specifics associated with the system fault are also described such that engineers are well informed and prepared to take proper actions in case their intervention is needed.

Second, the operational parameters are continuously reported to the maintenance center such that conditions can be predicted and prepared for in advance of actual breakdowns.

Third, the system provides visibility and efficiency that was not previously attainable using manual methods. The system provides the means by which a central maintenance operation is established. This central operation ensures all systems are operating at their optimal conditions and that maintenance requests are addressed in order of their severity. More importantly preventive measures can now be taken to prevent catastrophic failures before they actually occur. Logistical difficulties that face maintenance visits are especially compounded due to the congested traffic conditions. The proposed system provides the central maintenance center with the visibility and predictive tools needed to achieve efficiency, customer satisfaction and accordingly a superior medical service to the patients.

### Diagnosis of Fan-Motor Failures—CBR Automatic Response Example

Given: Symptoms, e.g., Upper Tank pressure dropped below the set 40 Bar
Goal: Find cause of failure and suggest repair procedure

### I—Example Cases Problem & Features

### Case 1:

Problem: Pressure below 40, above 10 Bar
   Motor Model: XXX
   Year: 1999
   Actual current drawn: 15.6 A (maximum value)
   Status of Electric Serive/breaker: OK
   Status of light alert: alert
Solution
   Diagnosis: Environmental overheat
   Repair: Switch electric cooling fan on

### Case 1 (Formalized):

Model(XXX),
Y(1999),
ActualCurrent(15.6),
ElectricBreaker(ok),
LightAlert(alert)

### Environmental Overheat

### Case 2:

Problem: Pressure below 50, above 20 Bar
   Motor Model: XXX
   Year: 2000
   Actual current drawn: 10 A(normal)
   Status of Electric Serive/breaker: OK
   State of light alert: OK
Solution
   Diagnosis: Circuit failure
   Repair: Replacement of casing

### Case 2(Formalized):

Model(XXXX),
Y(2000),
ActualCurrent(10),
ElectricBreaker(ok),
LightAlert(ok),

### Circuit Failure

### New Problem

Problem: Pressure below 10 Bar
Model: VVV
Year: 2002
Actual current draw: 13.7 A
Status of Electric Service/breaker: OK
State of light alert: alert

### New Case(Formalized Body):

Vehicle(VVV),
Y(2002),
ActualCurrent(13.7),
ElectricBreaker(ok),
LightAlert(alert),
Observations define a new problem
   Not all feature values may be known
   New problem=case without solution

### Steps of Algorithm 1:

Compare New Case with Case 1 (===: less important, === very important)
   Problem: Pressure below 40==80%==Pressure above 10 Bar (formally: sim(f_{Pressure}^{NewCase}, f_{Pressure}^{Case1})=0.8)
   Model: VVV==40%==Model: XXX
   Year: 2002==70%==Year: 1999
   Current: 15.6V==90%==Current: 13.7V
   State of breaker: OK==100%==State of breaker: OK
   State of alert light: alert==100%==State of alert light: alert
Use weighted average for ===(say: weight is 1) and ===(say: weight is 6)
Use similarity measures: “Pressure below 40, above 10 Bar” is 80% similar to “Pressure below 10”
Similarity by wted avg in the example=1/21 (6*0.8+1*0.4+1*0.7+6*0.9+6*1.0+6*1.0)=0.88
Repeat the same steps for all cases
Choose the best wted avg result

### II—Steps of Algorithm 2 (Adaptation and Reuse)

Suppose case 1 above became the best:
   Replace in Case 1
      Problem: “Pressure below 10” for “Pressure below 40, above 10”

### III—Storing New Cases (Case 3)

Problem: Pressure below 10
Vehicle: VVV
Year: 2002
Actual current draw: 13.7 A
Status of Electric Service/breaker: OK
State of light alert: alert
Diagnosis: Environmental Overheat
Repair: Switch electric cooling fan on

### DESCRIPTION OF THE DRAWINGS

The present invention may be better understood, and its numerous features and advantages made apparent to those skilled in the art by referencing the accompanying drawings.

FIG. 1 State-of-the-art;

FIG. 2 Solving problems in CBR;

FIG. 3 Apparatus components;

FIG. 4 Air-flow study dependent dimensions of the apparatus;

FIG. 5 A nearest-neighbor evaluation function;

FIG. 6 How to find the nearest neighbor of the new case NC.

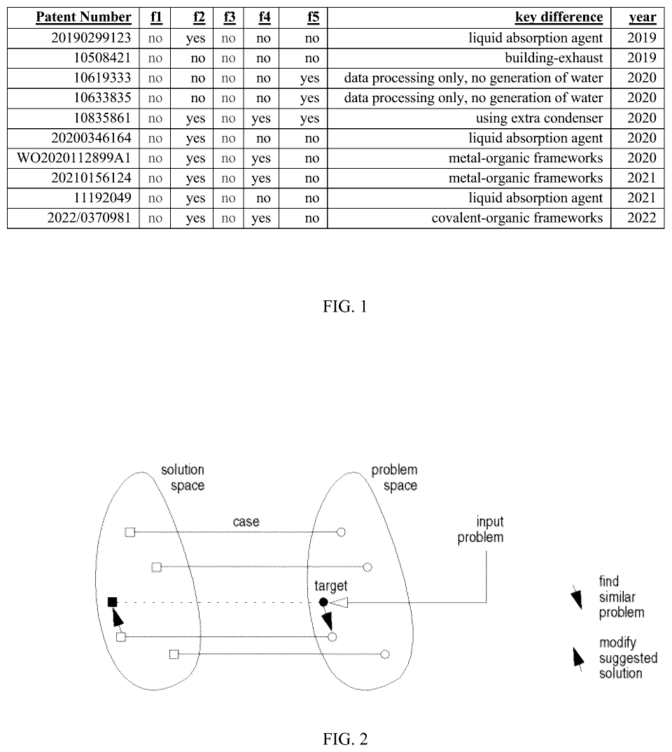

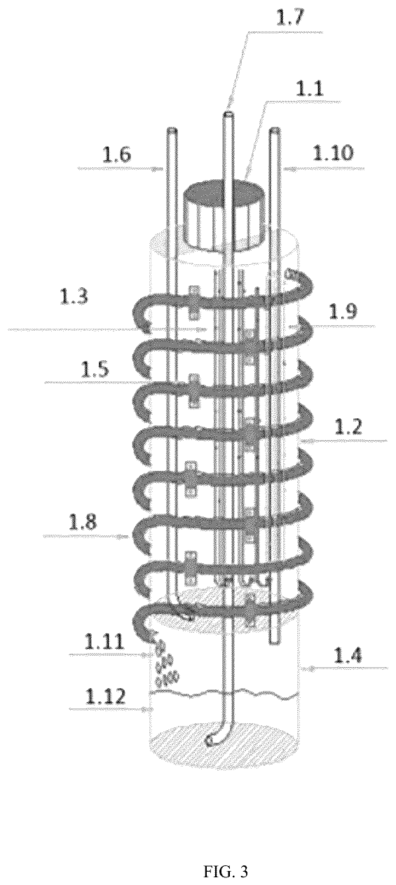

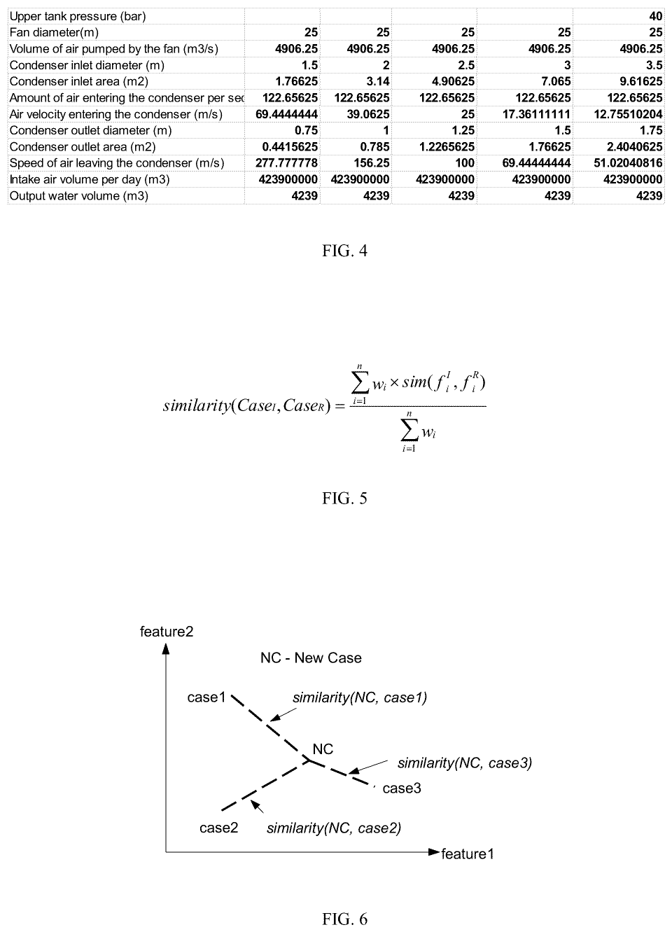

1- A computer system applied to a device, extracting water from air moisture, submerged to an adjustable depth of a large water reservoir, using Horn-Logics based software modules, wherein each Horn-Logics based software module comprises program instructions that, when executed, perform base functions that interact with a Horn-Logics formatted data source, each Horn-Logics based software module being callable by a software program module, and when called, is provided with information identifying a base function to be performed and a Horn-Logics program upon which the identified base function is to be performed, wherein one of the base functions is to: store and retrieve Horn-Logics programs representing instructions to the connected water extracting device, configuring of device sensors and set up of the working environment and the working parameters for the device using Horn-Logics programs, the water extraction device comprised of
A. An air-driven fan.
B. A metal cylinder of an adjustable diameter submerged in water to an adjustable depth and divided into two parts: The top part constituting an adjustable length of the cylinder and the lower part occupying the rest of the cylinder.
C. A spiral pipe that wraps around the device acting as a condenser.
D. Pipes to remove the air after condensation and enable flow to upper- and lower parts.

2- The system of claim 1 wherein one of the base functions is to translate data into Horn-Logics data formats from data sources attached to the device.

3- The system of claim 1 wherein one of the base functions is to route information from the computer system to the device using pre-defined Horn-Logics based routing rules.

4- The system of claim 1 wherein one of the base functions is to use a CBR based system engine to suggest, in Horn-Logics formats: Device configurations, modes of operation and repairs to defects reported by connected sensors as well as storing them in scheduling and planning data objects of the computer system.

5- The system according to claim 4, wherein the CBR based expert system engine uses Nearest neighbor retrieval and Parameter-value substitution methodologies to retrieve and adapt CBR cases, respectively.

6- The system of claim 1 wherein one of the based functions is to translate detected defects of a particular part of the device into Horn-Logics based programs.

7- The system of claim 1 wherein one of the base functions is to generate Horn-Logics based repair instructions and translate them into appropriate signals to be sent to the device.

8- The system of claim 1 wherein one of the base functions is to generate Horn-Logics based instructions and translate them into appropriate signals to be sent to the device.

9- The system of claim 1 wherein one of base functions is to read and update, in Horn-Logics formats, planning and scheduling data objects provided by base functions.

10- The system of claim 1 wherein one of the based function is to execute Horn-Logics based commands provided by base functions.
